(19) United States
(12) Patent Application Publication
(10) Pub. No.: US 2016/0249020 A1
(43) Pub. Date: Aug. 25, 2016

(54) SYSTEM AND METHOD OF LIVE STREAMING A FIRST PERSON VIEW OF A PLAYER IN A SPORTS EVENT

(71) Applicant: Garfield Mingo, East Orange, NJ (US)

(72) Inventor: Garfield Mingo, East Orange, NJ (US)

(21) Appl. No.: 15/048,414

(22) Filed: Feb. 19, 2016

Related U.S. Application Data
(60) Provisional application No. 62/118,066, filed on Feb. 19, 2015.

(51) Int. Cl. H04N 7/18; H04N 21/2187; H04N 21/4223; H04N 5/225

(52) U.S. Cl. CPC H04N 7/185; H04N 5/2257; H04N 21/2187; H04N 21/4223

(57) ABSTRACT

A system and method for streaming a first person view of a player in a sports event is provided. The system and method may include sports apparel formed to fit on at least a portion of a human body, such as the player. A video camera is secured to the sports apparel. A wireless transmitter is operable to transmit a live stream of video captured by the video camera. A remote device having a processor, a receiver, and a display, receives the live stream of video, and the processor is operable to produce the live stream of video on the display.

### CROSS-REFERENCE TO RELATED APPLICATION

This application claims the benefit of priority of U.S. provisional application No. 62/118,066, filed Feb. 19, 2015, the contents of which are herein incorporated by reference.

### BACKGROUND OF THE INVENTION

The present invention relates to broadcasting sports events and, more particularly, to a system of live streaming a first person view of a player in a sports event.

The broadcasting of sports events is the live coverage of sports as a television program, on radio, and other broadcasting media. Internet broadcasts are also common, though college and major professional sports either use a pay wall or subscriber-based systems to extract payment. Certain sports fans have a desire to be as close to the game as possible. However, watching the sports event remotely on a screen or sitting in the stand only provides a third person viewing.

As can be seen, there is a need for an alternate viewing of sports events that brings sports fans closer to the game.

### SUMMARY OF THE INVENTION

In one aspect of the present invention, a system of live streaming a first person view of a player in a sports event comprising: a sports apparel formed to fit on at least a portion of a human body; a video camera secured to the sports apparel; a wireless transmitter operable to transmit a live stream of video captured by the video camera; and a remote device comprising a processor, a receiver, and a display, wherein the receiver is operable to receive the live stream of video; and the processor is operable to produce the live stream of video on the display.

In another aspect of the present invention, a method of live streaming a first person view of a player in a sports event comprising: providing a sports apparel comprising a video camera and a wireless transmitter, wherein the player is wearing the sports apparel; transmitting a live feed of the player playing in the sports event to a receiver of a remote device, wherein the remote device comprises a processor, and a display; and producing the live feed of the player playing in the sports event on the display via software running on the processor.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a schematic view of an embodiment of the present invention;

FIG. 3 is a flow chart of an exemplary method of the present invention; and

FIG. 4 is a schematic view of an embodiment of the present invention, showing the first person perspective of a player being projected on multiple remote devices.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a system and method of providing a first person view of a sporting event via live streaming. Using the present invention, sports fans may sign up for a service that provides a live streaming view of a sports event via a camera secured to the player(s) sporting apparel. The present invention provides sports fans with the ability to connect to their favorite player(s) and view the game as it is being played through the player(s) sporting apparel. Currently, video broadcasting only shows a sporting game in third person view, but the present invention allows the sports fan to watch the game in first person view.

Each sport may include a slightly different set up. For example football, baseball, or hockey may include helmets with video cameras. Other sports, such as baseball, basketball or soccer, may include specially made shirts, pants or hats. The helmet may include a rigid housing or visor to protect the video camera, which may be located on the front center of the helmet. The video camera may also be connected to a wireless network to transfer data over the internet. The wiring inside of the helmet is connected properly so that the wiring does not interfere with the athlete and is able to withstand different weather conditions. The internet is used to connect millions of fans to their favorite team(s), but most importantly to their favorite player(s).

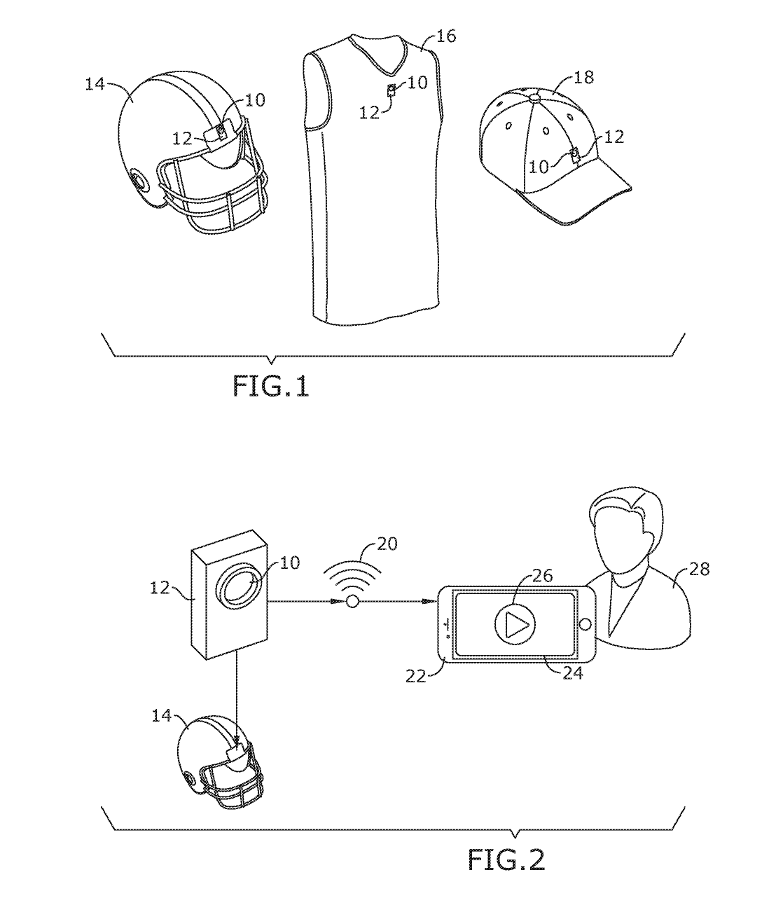

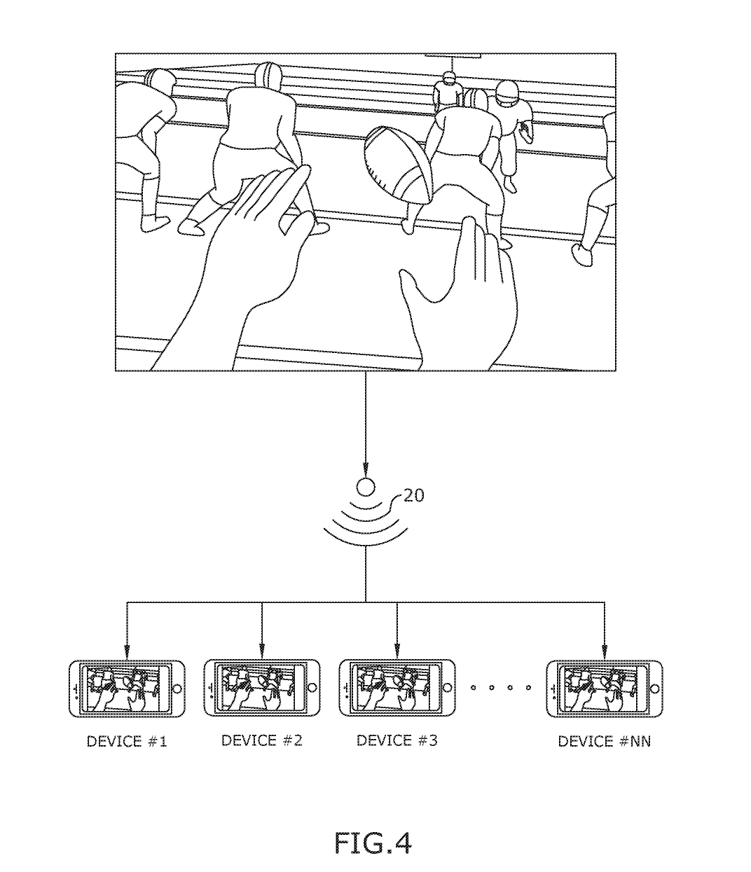

Referring to FIGS. 1, 2 and 4, the present invention includes a system for streaming a first person view of a player in a sports event. The system may include sports apparel 14, 16, 18 formed to fit on at least a portion of a human body, such as the player. A video camera 10 is secured to the sports apparel 14, 16, 18. A wireless transmitter is operable to transmit a live stream of video 26 captured by the video camera 10. A remote device 22 having a processor, a receiver, and a display 24, receives the live stream of video 26, and the processor is operable to produce the live stream of video 26 on the display 24.

In certain embodiments, the video camera 19 the wireless transmitter are embedded within the sports apparel 14, 16, 18. To protect the video camera 10 and the wireless transmitter, the present invention may include a rigid housing 12. The rigid housing 12 may be formed of a rigid material that is difficult to break, such as a metal or hard plastic. The rigid housing 12 is secured directly to the sports apparel 14, 16, 18 and the video camera 10 and the wireless transmitter are disposed within the rigid housing 12.

The type of sports apparel 14, 16, 18 depends on the type of sports event being played. For example, if the sports event is football, hockey, horse racing, lacrosse, skiing, skateboarding, and the like, the sports apparel may be a helmet 14. In such embodiments, the rigid housing 12 may be positioned in the front center of the helmet 14. For sports such as basketball, tennis, soccer and the like, the sports apparel may be an athletic shirt or jersey 16. For sports that require hats, such as baseball, the sports apparel may be a hat 18.

In certain embodiments, the wireless transmitter may be connected to a wireless local area network, such as Wi-Fi. The wireless local area network may be connected to the internet 20. Further, the receiver of the remote device 22 may also be connected to a wireless local area network connected to the internet 20. Therefore, the live streaming video 26 may be transferred from the video camera 10 to the remote device 22 via the internet 20. A user 28 may then stream the first person view on the remote device 22, such as a smart phone, tablet, smart television, gaming system, and the like.

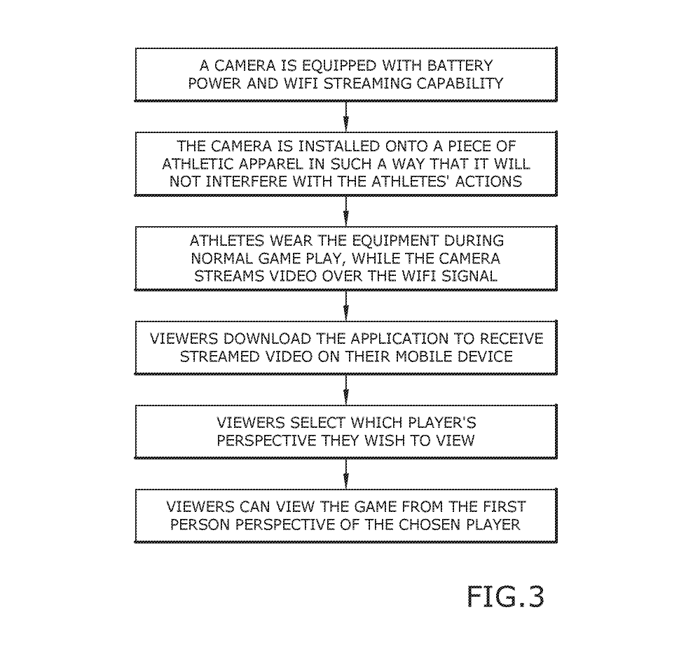

As illustrated in FIG. 3, the present invention may further include a method of streaming a first person view of a player in a sports event. The method may include the following steps: providing at least one sports apparel comprising a video camera and a wireless transmitter, wherein the player is wearing the at least one sports apparel; transmitting a live feed of the player playing in the sports event from the wireless transmitter to a receiver of a remote device, wherein the remote device comprises a processor, and a display; and producing the live feed of the player playing in the sports event on the display via software running on the processor.

In certain embodiments, the remote device may include a smart phone. An application may be loaded on the smart phone to receive and provide the live feed. Further, the present invention may include a plurality of sports apparels, where each of the sports apparels is worn by different players of the sporting event. In such embodiments, the user may select which first person view they would prefer to live stream on their smart phone. Therefore, the present invention may further include the step of: selecting to receive a live feed from at least one of the video cameras of the plurality of sports apparel via software running on the processor.

It should be understood, of course, that the foregoing relates to exemplary embodiments of the invention and that modifications may be made without departing from the spirit and scope of the invention as set forth in the following claims.

What is claimed is:

1. A system for streaming a first person view of a player in a sports event comprising:
a sports apparel formed to fit on at least a portion of a human body;
a video camera secured to the sports apparel;
a wireless transmitter operable to transmit a live stream of video captured by the video camera; and
a remote device comprising a processor, a receiver, and a display, wherein
the receiver is operable to receive the live stream of video; and
the processor is operable to produce the live stream of video on the display.

2. The system of claim 1, further comprising a rigid housing secured to the sports apparel, wherein the video camera and the wireless transmitter are disposed within the rigid housing.

3. The system of claim 1, wherein the video camera and the wireless transmitter are embedded within the sports apparel.

4. The system of claim 1, wherein the sports apparel is one of a helmet, a shirt and a hat.

5. The system of claim 1, wherein the wireless transmitter is connected to a wireless local area network connected to an internet, wherein the live stream of video is transferred over the internet.

6. The system of claim 1, wherein the remote device is a smart phone.

7. A method of streaming a first person view of a player in a sports event comprising:
providing at least one sports apparel comprising a video camera and a wireless transmitter, wherein the player is wearing the at least one sports apparel;
transmitting a live feed of the player playing in the sports event from the wireless transmitter to a receiver of a remote device, wherein the remote device comprises a processor, and a display; and
producing the live feed of the player playing in the sports event on the display via software running on the processor.

8. The method of claim 7, wherein the sports apparel further comprises a rigid housing, wherein the video camera and the wireless transmitter are disposed within the rigid housing.

9. The method of claim 7, wherein the video camera and the wireless transmitter are embedded within the sports apparel.

10. The method of claim 7, wherein the sports apparel is one of a helmet, a shirt and a hat.

11. The method of claim 7, wherein the wireless transmitter is connected to a wireless local area network connected to an internet, wherein the live stream of video is transferred over the internet.

12. The method of claim 7, wherein the remote device is a smart phone.

13. The method of claim 7, wherein the at least one sports apparel is a plurality of sports apparel, wherein a plurality of players are each wearing one of the plurality of sports apparel.

14. The method of claim 13, further comprising the step of:
selecting to receive a live feed from at least one of the video cameras of the plurality of sports apparel via software running on the processor.
